(19) United States
(12) Patent Application Publication
(10) Pub. No.: US 2024/0227507 A1
(43) Pub. Date: Jul. 11, 2024

(54) HEATING DEVICE FOR VEHICLE

(71) Applicant: Hanon Systems, Daejeon (KR)

(72) Inventors: Dong Hoon OH, Daejeon (KR); Dae Bok KEON, Daejeon (KR); Jeong Man LEE, Daejeon (KR)

(21) Appl. No.: 18/560,969

(22) PCT Filed: Nov. 9, 2022
(86) PCT No.: PCT/KR22/17501

§ 371 Date: Nov. 15, 2023

(30) Foreign Application Priority Data
Dec. 3, 2021 (KR) 10-2021-0171877
Dec. 3, 2021 (KR) 10-2021-0171934

(51) Int. Cl. B60H 1/22; H05B 3/26

(52) U.S. Cl. CPC B60H 1/2225; H05B 3/26

(57) ABSTRACT

Disclosed is a heating device for a vehicle, enabling substantially increased heat transfer efficiency, excellent rapid heating, and reduced weight and package. The heating device for a vehicle comprises: a film heating unit comprising a heating element, and a film covering both sides of the heating element in the thickness direction; and a heat dissipation unit comprising a pair of plates spaced in the thickness direction, and a heat-dissipating fin interposed between the pair of plates, wherein the film heating unit and the heat dissipation unit are sequentially laminated by attaching the plates to the film.

### TECHNICAL FIELD

The present invention relates to a heating device for a vehicle, and more specifically, to a heating device for a vehicle which is installed in an air passage of an air conditioner for a vehicle and exchanges heat with air passing therethrough to heat the air.

### BACKGROUND ART

In general, an air conditioner for a vehicle is an apparatus for cooling or heating the interior of the vehicle by heating or cooling air. Such an air conditioner for a vehicle includes an evaporator, which is a cooling device, and a heater core, which is a heating device, inside an air-conditioning case, and selectively blows the air cooled by the evaporator or heated by the heater core toward parts of the interior of the vehicle.

Such a heating device for a vehicle uses a heater core which utilizes coolant as a heat source, or an indoor heat exchanger which uses refrigerant as a heat source, and uses a PTC heater, which generates heat by applying power, as an auxiliary heating device. Particularly, an electric vehicle which has no engine uses the PTC heater as a main heating device. Korean Patent Laid-Open Publication No. 10-2020-0089792 discloses a high-voltage PTC heater which is installed in an air conditioner for a vehicle.

The conventional high-voltage PTC heater includes a heat rod, a heat dissipation structure, a chassis frame, and a chassis housing. The heat rod includes a PTC element, extends in one direction, and a plurality of heat rods are spaced apart in a lateral direction. In addition, the heat dissipation structure is interposed between adjacent heat rods. The chassis frame couples and fixes the assembly of the heat rod and the heat dissipation structure on both sides and one end thereof.

The chassis housing is coupled to the other end of the assembly of the heat rod and the heat dissipation structure, and a ground wire passes therethrough. Moreover, the chassis housing includes a conductive heat sink to which the ground wire is connected. A conductive rod chassis which is closely assembled to the heat sink and the heat rod in an elastically pressed manner is interposed between the heat sink and the heat rod.

Since the PTC elements and the heat dissipation structure are adhered by silicon bonding, the conventional high-voltage PTC heater has several disadvantages in that the thermal resistance significantly increases, efficiency and speed of response are low, and the weight and the package size are increased due to silicon bonding. On the other hand, a heating device for a vehicle, which uses not the PTC heater but other heating elements, but such a heating device is only used for low voltage and cannot be used for high voltage.

Meanwhile, the conventional PTC heater improves indoor heating performance during initial startup when being used in an air conditioner for a vehicle. The PTC heater has a plurality of space parts which penetrate the upper and lower surfaces of an insulation support body and are spaced apart in parallel to the length direction. Each of the space parts of the insulation support body includes a temperature control heating part in which a plurality of PTC elements are interposed.

The temperature control heating part includes two or more types of PTC elements with different Curie points. As described above, the temperature control heating part is formed so that the left and right sides from the center in the length direction are different from each other in heating temperature, thereby generating a temperature difference between the left and right sides of the interior of the vehicle.

The conventional PTC heater is configured to generate a temperature difference between the left and right sides of the temperature control heating part to realize independent air conditioning at the left and right sides of the interior of the vehicle. So, the temperature control heating part requires at least two or more types of PTC elements, leading to an increase in manufacturing cost. Furthermore, the conventional PTC heater has a disadvantage in that unbalanced temperature difference control at the left and right sides occurs due to the asymmetric arrangement of the PTC elements.

### DISCLOSURE

### Technical Problem

Accordingly, the present invention has been made in view of the above-mentioned problems occurring in the related art, and it is an objective of the present invention to provide a heating device for a vehicle, which enables substantially increased heat transfer efficiency, excellent rapid heating, and reduced weight and package.

It is another objective of the present invention to provide a heating device for a vehicle, which can be manufactured for high voltage use, has excellent temperature uniformity across the entire heating area, and has high stability and excellent assembly and durability.

It is a further objective of the present invention to provide a heating device for a vehicle, which enables independent temperature control at the left and right sides, and has a small size and thermal capacity of the heating element, thereby providing rapid responsiveness and reducing a size of a heater package.

### Technical Solution

To accomplish the above-mentioned objects, according to the present invention, there is provided a heating device for a vehicle including: a film heating unit which includes a heating element, and a film covering both sides of the heating element in the thickness direction; and a heat dissipation unit which includes a pair of plates spaced apart from each other in the thickness direction, and a heat-dissipating fin which is interposed between the pair of plates, wherein the film heating unit and the heat dissipation unit are sequentially laminated by attaching the plates to the film.

The heating element is connected to a positive (+) electrode and a negative (−) electrode as a conductor, and the film is made with an insulator to insulate between the heating element and the heat dissipation unit.

The heat dissipation unit is made by brazing the plates and the heat-dissipating fins, and then, is bonded to the thin film heating unit.

The heating device for a vehicle further includes a gap maintaining means which is provided between the plate and the film.

A protrusion of an embossed shape is formed on one side of the plate facing the film.

A grid pattern is formed on one side of the plate facing the film.

A bending part is formed at the end of the plate, and the bending part covers and supports the side of the film heating unit.

The bending part is formed on only one of the pair of plates facing each other in one heat dissipation unit. The film heating unit is inserted between the plate, on which the bending part of one heat dissipation unit is formed, and the plate, on which the bending part of one heat dissipation unit is not formed, and then, is compressed, supported, and clamped to the bending part of the plate facing the plate, on which the bending part of one heat dissipation unit is not formed.

A bonding layer between the film heating unit and the heat dissipation unit is made by silicon bonding.

The multiple laminated film heating unit and heat dissipation unit are insulated from each other, and terminals are provided to individually supply power to the electrodes connected to the heating element of each film heating unit.

In another aspect of the present invention, there is provided a heating device for a vehicle including: a film heating unit which includes a heating element connected to a positive (+) electrode and a negative (−) electrode as a conductor, and a film covering both sides of the heating element in the thickness direction and made with an insulator, wherein the heating element includes a plurality of heating layers, and the plurality of heating layers can be controlled independently by a single power supply part.

The heating element includes a left side heating part and a right heating part, and is configured to control the temperatures on the left and right sides inside the vehicle through independent control of the left heating part and the right heating part by a single power supply part.

The heating device for a vehicle further includes a heat dissipation unit which includes a pair of plates spaced apart from each other in the thickness direction, and a heat-dissipating fin interposed between the pair of plates, and the plates are attached to the thin film, and the film heating unit and the heat dissipation unit are sequentially laminated.

A rigid base support is attached to one surface of the film heating unit, and the base support is in surface contact with the entire film heating unit to transfer heat to the plate.

The film heating unit includes an NTC resistor between the positive (+) electrode and the negative (−) electrode, and the NTC resistor induces current by lowering a resistance value when the temperature is above a reference temperature, thereby blocking the flow of current to the heating element.

The heating element includes a first heating layer and a second heating layer laminated in the thickness direction, the first heating layer includes a left side heating pattern and a left side electrode, and the second heating layer includes a right side heating pattern and a right side electrode.

The heating element includes a first heating layer and a second heating layer laminated in the thickness direction, the first heating layer includes a left side heating pattern, a right side heating pattern, and a left side electrode, the second heating layer includes a right side electrode, and the first heating layer has a right side connection part to be connected to the right side electrode of the second heating layer.

The negative (−) electrode for the first heating layer and the second heating layer is commonly used.

### Advantageous Effect

The heating device for a vehicle according to the present invention can substantially increase heat transfer efficiency, provide excellent rapid heating, and reduce weight and package. Moreover, the heating device for a vehicle according to the present invention can be manufactured for high voltage use, has excellent temperature uniformity across the entire heating area, and has high stability and excellent assembly and durability.

In addition, the heating device for a vehicle enables independent temperature control at the left and right sides, and has a small size and thermal capacity of the heating element, thereby providing rapid responsiveness and reducing a size of a heater package.

### BRIEF DESCRIPTION OF THE DRAWINGS

FIG. 1 is a perspective view illustrating a film heating unit and a heat dissipation unit according to a first embodiment of the present invention.

FIG. 2 is an exploded perspective view illustrating the film heating unit and the heat dissipation unit according to the first embodiment of the present invention.

FIG. 3 is an exploded perspective view illustrating the film heating unit according to the first embodiment of the present invention.

FIG. 4 is a perspective view illustrating a heating device for a vehicle according to the first embodiment of the present invention.

FIG. 5 is a front view illustrating the heating device for a vehicle according to the first embodiment of the present invention.

FIG. 6 is a perspective view illustrating a heat dissipation unit according to a second embodiment of the present invention.

FIG. 7 is a cross-sectional view taken along line A-A of FIG. 6.

FIG. 8 is a cross-sectional view illustrating a state in which a film heating unit is attached to a heat dissipation unit according to the second embodiment of the present invention.

FIG. 9 is an exploded perspective view illustrating a film heating unit and a heat dissipation unit according to a third embodiment of the present invention.

FIG. 10 is a cross-sectional view illustrating a disassembled state of the film heating unit and the heat dissipation unit according to the third embodiment of the present invention.

FIG. 11 is a cross-sectional view illustrating an assembled state of the film heating unit and the heat dissipation unit according to the third embodiment of the present invention.

FIG. 12 is an exploded perspective view illustrating ta film heating unit according to a fourth embodiment of the present invention.

FIG. 13 is an exploded perspective view illustrating a film heating unit and a base support according to a fifth embodiment of the present invention.

FIG. 14 is a plan view illustrating the film heating unit and the base support according to the fifth embodiment of the present invention.

FIG. 15 is a plan view illustrating a film heating unit according to a sixth embodiment of the present invention.

FIG. 16 illustrates a film heating unit according to a seventh embodiment of the present invention.

FIG. 17 illustrates a film heating unit according to an eighth embodiment of the present invention.

### MODE FOR INVENTION

Hereinafter, the technical configuration of a heating device for a vehicle will be described in detail with reference to the accompanying drawings.

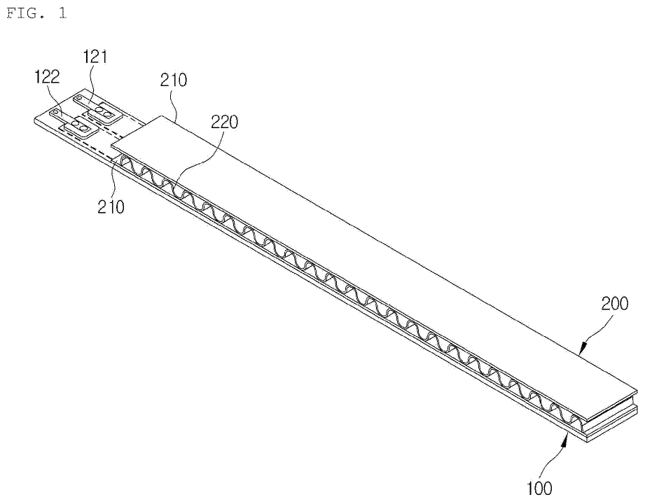

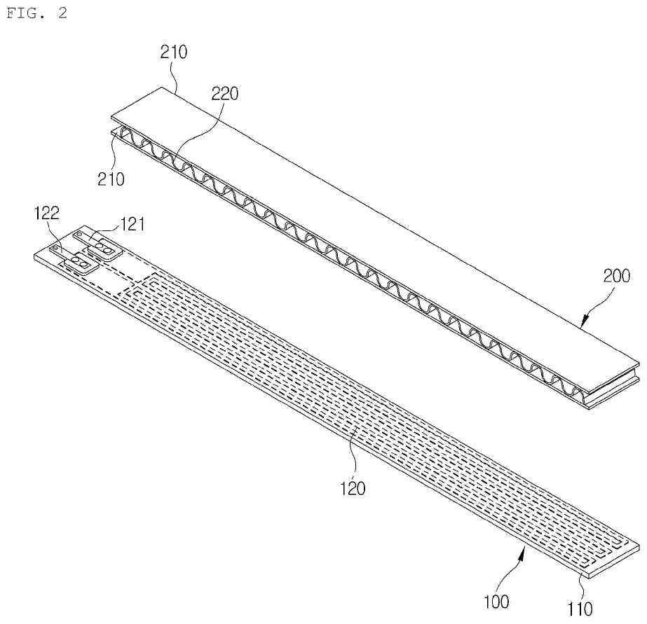

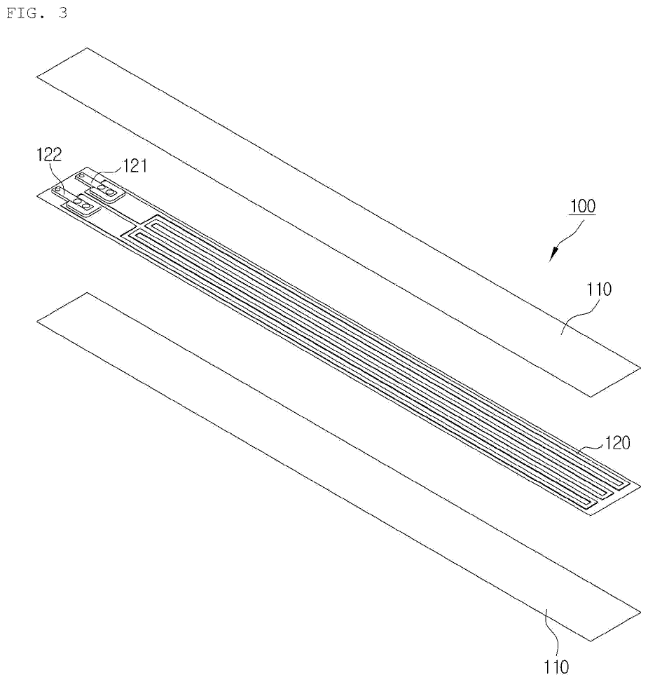

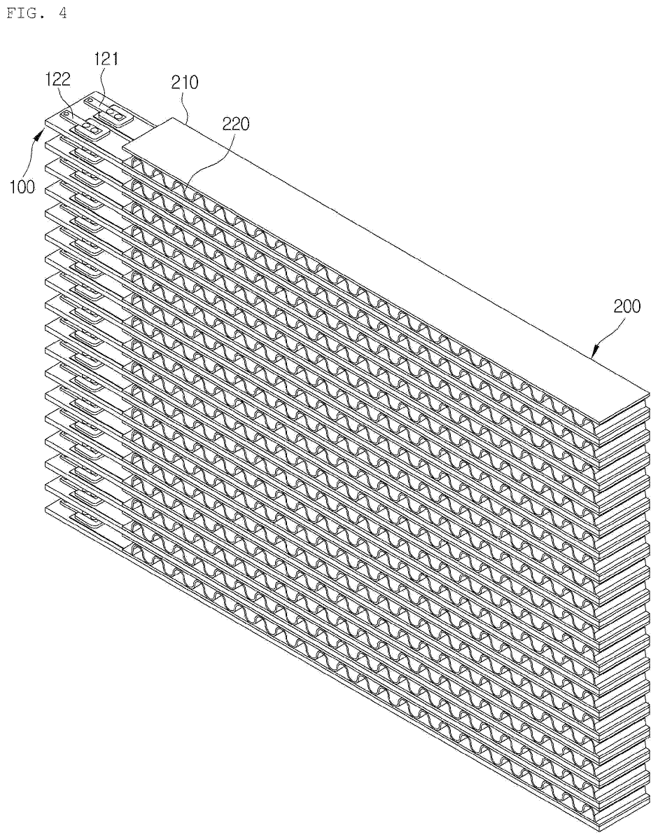

Referring to FIGS. 1 to 5, a heating device for a vehicle according to a first embodiment of the present invention is installed in an air passage within an air conditioning case of an air conditioner, and heats air by exchanging heat with air passing therethrough. The heating device for a vehicle includes a film heating unit 100 and a heat dissipation unit 200. The film heating unit 100 and the heat dissipation unit 200 are sequentially stacked.

The film heating unit 100 includes a heating element 120 and films 110. The heating element 120 is made of a conductor, and a positive (+) electrode 121 and a negative (−) electrode 122 are connected to one side of the heating element. The heating element 120 has a predetermined pattern, and generates heat by electrical resistance when power is applied. One end of the heating element 120 is connected to the positive electrode 121, and the other end is connected to the negative electrode 122. Moreover, the film 110 is in a thin sheet form with a small thickness and is made of an insulator.

The films 110 are provided in a pair, and cover both sides of the heating element 120 in the thickness direction. Furthermore, the films 110 are made of a material which transfers heat well. That is, the heating element 120 is located between the pair of films 110, the electricity passing through the heating element 120 is insulated by the films 110, and the heat generated from the heating element 120 is smoothly transferred to the heat dissipation unit 200 through the films 110.

The heat dissipation unit 200 includes a pair of plates 210 and a heat-dissipating fin 220. The pair of plates 210 are spaced apart from each other in the thickness direction, and the heat-dissipating fin 220 is interposed between the pair of plates 210. The heat-dissipating fin 220 is configured to increase a contact area for heat exchange with the air through a plurality of corrugated shapes, thereby ensuring smooth heating of the air. Both the plates 210 and the heat-dissipating fin 220 are made of a material with excellent thermal conductivity, and for example, can be made of aluminum (Al).

The heat dissipation unit 200 is made by brazing the plates 210 and the heat-dissipating fin 220, and then, is bonded to the thin film heating unit 100. Due to the characteristics of the brazing process, the heat dissipation unit 200 and the film heating unit 100 cannot be brazed together at high temperature. Therefore, after the plates 210 and the heat-dissipating fin 220 are manufactured by brazing, the integrally bonded plate and heat-dissipating fin module (heat dissipation unit: 200) are bonded to the film heating unit 100.

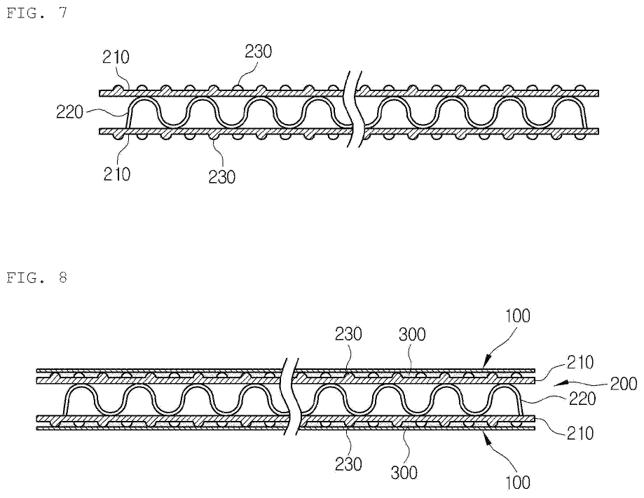

Referring further to FIG. 8, it is preferable that the bonding layer 300 between the film heating unit 100 and the heat dissipation unit 200 is made by silicone bonding. The bonding layer 300 is made of a material with excellent thermal conductivity, and since the film 110 serves as an insulator, the material for the bonding layer 300 can be freely selected from materials that either conduct or do not conduct electricity. The silicone bonding layer 300 smoothly transfers the heat generated in the film heating unit 100 to the heat dissipation unit 200, and also provides excellent insulation to insulate between the film heating unit 100 and the heat dissipation unit 200.

As described above, the multiple stacked film heating units 100 and heat dissipation units 200 are insulated from each other. Furthermore, terminals are formed to individually supply power to the electrodes 121 and 122 connected to the heating element 120 of each film heating unit 100. The plate 210 of the heat dissipation unit 200 is attached to the film 110 of the film heating unit 100 by bonding, and due to the insulating properties of the film 110, the heating element 120 is insulated from the heat dissipation unit 200.

Through the above configuration, the heating device for a vehicle according to the present invention can be realized for high voltage use. Such an insulation structure of the present invention is distinguished from the low-voltage heater structure, which connects each heat dissipation unit and heating unit through a conductor to conduct electricity to the entire heating device. That is, the heating device for a vehicle of the present invention can be applied as a high-voltage heater for a vehicle through the insulation structure and the heat transfer structure between the film heating unit 100 and the heat dissipation unit 200.

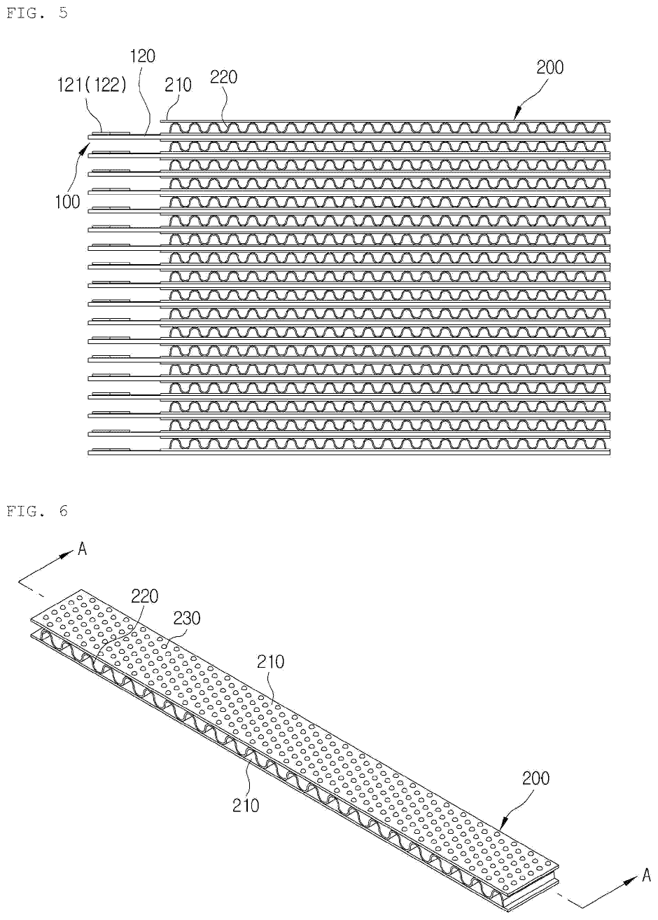

Meanwhile, referring to FIGS. 6 to 8, a heating device for a vehicle according to a second embodiment of the present invention further includes a gap maintaining means. The gap maintaining means is provided between the plate 210 of the heat dissipation unit 200 and the film 110 of the film heating unit 100, and can be configured as a protrusion 230 with an embossed shape or as a pattern of a lattice shape. In this embodiment, the gap maintaining means has the structure of the protrusion 230.

The protrusion 230 with an embossed shape is uniformly formed across the entire surface of one side of the plate 210 facing the film 110 of the film heating unit 100. As the protrusion 230 closely supports the film 110 during the bonding between the film 110 and the plate 210, a gap between the film 110 and the plate 210 is maintained constantly. It is preferable that the protrusion 230 or the pattern is formed very thinly, approximately in the range of 50 μm to 100 μm in thickness.

As described above, since the gap maintaining means having the protrusion 230 or the pattern is provided, it is possible to adjust the thickness of the applied silicon adhesive (bonding layer: 300) and to maintain the uniform thickness of the bonding layer 300 between the film heating unit 100 and the plate 210, thereby ensuring temperature uniformity and stability during operation.

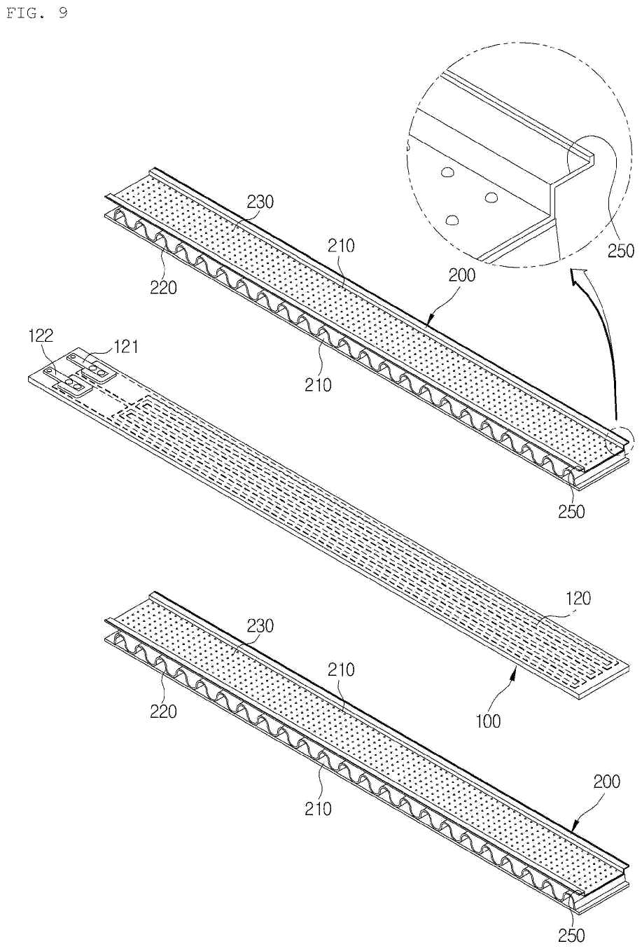

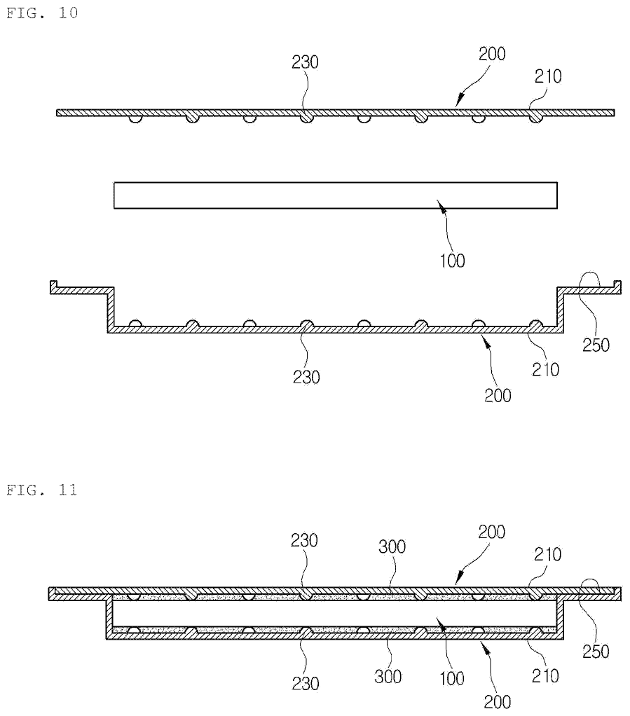

Meanwhile, referring to FIGS. 9 to 11, a heating device for a vehicle according to a third embodiment of the present invention further includes a bending part 250. The bending part 250 is formed to be bent at 90° at the end of the plate 210 of the heat dissipation unit 200 to create a stepped portion. The bending part 250 can be formed on both sides in the transverse direction, on both sides in the longitudinal direction, or along the periphery across the entire transverse and longitudinal directions of the plate 210.

Additionally, the bending part 250 is formed on only one of the pair of facing plates 210 of the heat dissipation unit 200. That is, the bending part 250 is formed on the plate 210 located on the upper side in the stacking direction, but is not formed on the plate 210 located on the lower side.

The film heating unit 100 is inserted between the plate 210 of one heat dissipation unit 200, on which the bending part 250 is formed, and the plate 210 of another neighboring heat dissipation unit 200, on which the bending part 250 is not formed. In addition, the film heating unit 100 is compressed, supported, and clamped to the bending part 250 of the plate 210 facing the plate 210 on which the bending part 250 is not formed. Through the above structure, a robust fixation between the heat dissipation unit 200 and the film heating unit 100 is achieved, and the stacked module of the heat dissipation unit 200 and the film heating unit 100 can be completed without a separate external frame.

In other words, the bending part 250 is formed on the upper plate 210 of one heat dissipation unit 200, and no bending part is formed on the lower plate 210. The film heating unit 100 is placed on the bending part 250 formed on the upper plate 210, and the lower plate 210 of the another heat dissipation unit 200 facing the upper side of one heat dissipation unit 200 is compressed, supported, and clamped to the bending part 250.

More specifically, the bending part 250 has a structure to extend vertically from the end of the plate 210, and then to extend horizontally. Through such a configuration, the bending part 250 serves to cover and support the side surface of the film heating unit 100. The bending part 250 facilitates the alignment of the film heating unit 100 and prevents the silicon bonding layer 300 from overflowing and leaking out of the plate 210.

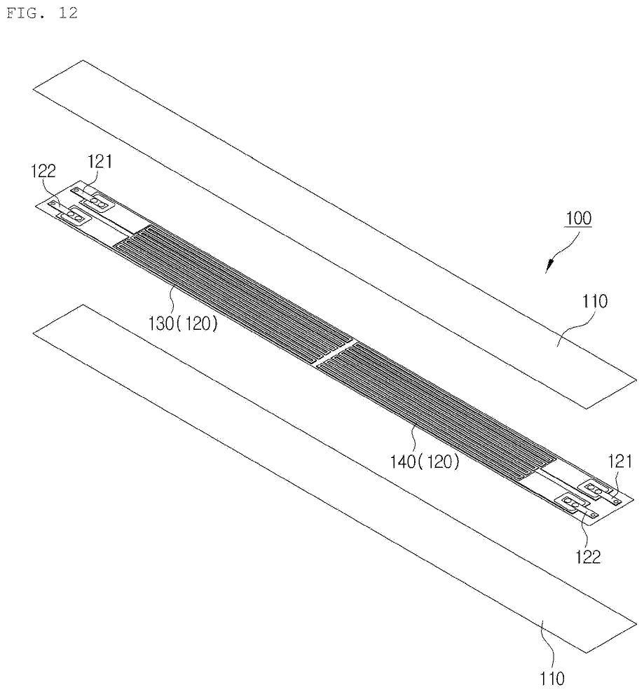

Referring to FIG. 12, a film heating unit 100 according to a fourth embodiment of the present invention is configured to allow for individual heating control on both sides (left and right sides) based on approximately the central part in the longitudinal direction of the film 110, for independent right and left air conditioning inside the vehicle. The heating element 120 includes a left heating part 130 and a right heating part 140, and is configured to control the temperatures on the left and right sides inside the vehicle through independent control of the left heating part 130 and the right heating part 140 by a single power supply part.

That is, the left heating part 130 forms a left side heating pattern, and a positive (+) electrode 121 and a negative (−) electrode 122 are connected to the left side heating pattern. Additionally, the right heating part 140 forms a right side heating pattern, and a positive (+) electrode 121 and a negative (−) electrode 122 are connected to the right side heating pattern. A pair of films 110 are laminated on both sides in the thickness direction of the left heating part 130 and the right heating part 140 to create a thin film heating unit 100.

Through such a configuration, in a case in which the air conditioner for a vehicle has a dual automatic temperature control (DATC) function, it is possible to realize independent air conditioning on the left and right sides by changing the pattern of the heating element 120, and the heating element 120 can be made smaller in size and thermal capacity, thereby enabling rapid responsiveness and reducing the heater package.

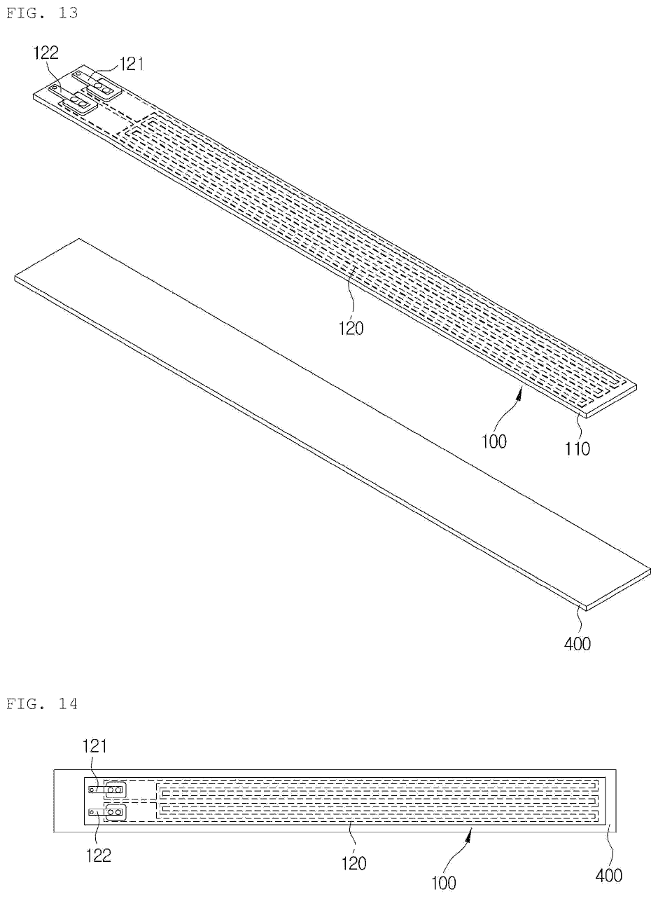

Referring to FIGS. 13 and 14, a heating device according to a fifth embodiment of the present invention further includes a base support 400. The base support 400 is attached to one surface of the film heating unit 100, and is made of a rigid material. The base support 400 is in surface contact with the entire surface of the film 110 of the film heating unit 100, and is configured to transfer heat to the plate 210 of the heat dissipation unit 200.

The base support 400 is formed larger than the film heating unit 100, so that the entire film heating unit 100 is in surface contact with the base support 400. Preferably, the base support 400 is made of a metal material with excellent heat transfer performance. The base support 400 robustly supports the film heating unit 100, which is made of a flexible material and is weak and easily deformed, facilitates assembly with the heat dissipation unit 200, and functions to diffuse heat so that it can be evenly transferred to the heat dissipation unit 200.

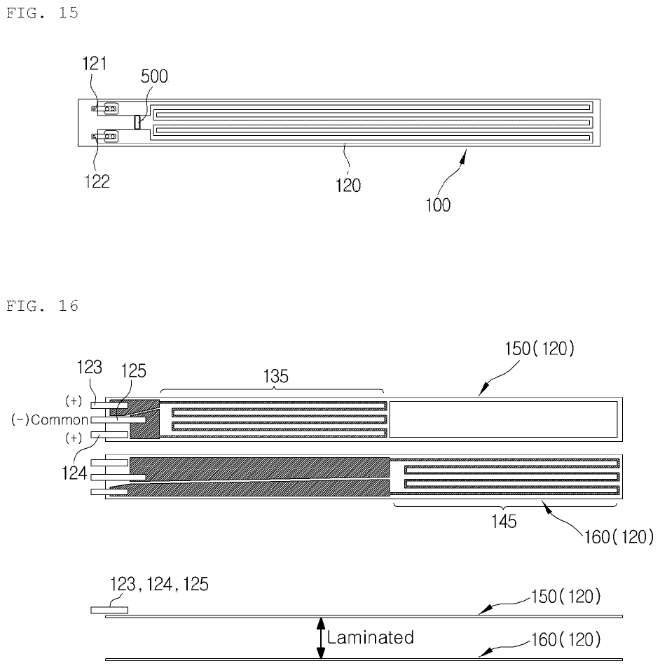

Referring to FIG. 15, a film heating unit 100 according to a sixth embodiment of the present invention further includes a negative temperature coefficient (NTC) resistor 500. The NTC resistor 500 includes an NTC thermistor, and has characteristics to increase a resistance value within a normal temperature range and decrease a resistance value at relatively low temperatures. The NTC resistor 500 functions as an overheating safety device.

In other words, the NTC resistor 500 is formed between the positive (+) electrode 121 and the negative (−) electrode 122, and when the temperature exceeds a reference temperature, its resistance value decreases to induce the current flow from the positive (+) electrode 121 to the negative (−) electrode 122, thereby blocking the current flow to the heating element 120. In the event of overheating, the NTC resistor 500 diverts the current flowing to the heating element 120 to the NTC resistor 500 due to the decreased resistance, thereby alleviating the overheating phenomenon.

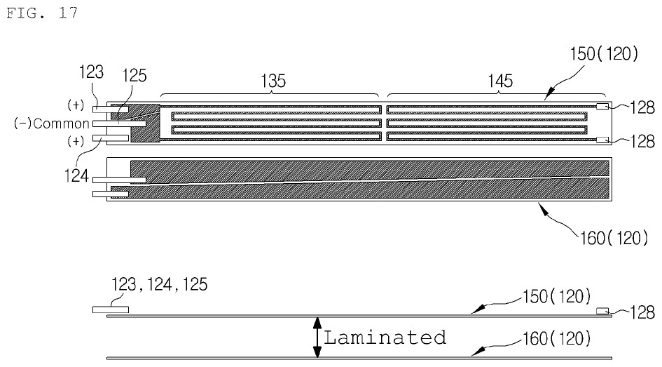

Referring to FIG. 16, a film heating unit 100 according to a seventh embodiment of the present invention includes a heating element 120, wherein the heating element 1 includes a plurality of heating layers. Furthermore, the film heating unit 100 according to the seventh embodiment of the present invention is configured to enable independent control of the plurality of heating layers by a single power supply part.

The heating element 120 includes a first heating layer 150 and a second heating layer 160. The first heating layer 150 and the second heating layer 160 are each formed in a very thin sheet shape and are laminated in the thickness direction. More specifically, the first heating layer 150 includes a left side heating pattern 135 and a left side electrode. Additionally, the second heating layer 160 includes a right side heating pattern 145 and a right side electrode.

In other words, the left side heating pattern 135 for generating heat according to the application of power is formed on one side (left side) of the first heating layer 150 based on approximately the central part in the length direction, and no heating pattern is formed on the other side (right side). Moreover, no heating pattern is formed on one side (left side) of the second heating layer 160, and the right side heating pattern 145 for heating according to the application of power is formed on the other side (right side) of the second heating layer 160.

The left side heating pattern 135 functions as a left side heating part, and the right side heating pattern 145 functions as a right side heating part. The left side electrode includes a positive (+) electrode 123 and a negative (−) electrode 125, and the right side electrode includes a positive (+) electrode 124 and a negative (−) electrode 125. The negative (−) electrode 125 for the first heating layer 150 and the second heating layer 160 is commonly used. Through the above configuration, a temperature difference between the left side and the right side can be formed with one type of heating element specification to realize a dual automatic temperature control (DATC) function.

Meanwhile, referring to FIG. 17, a film heating unit 100 according to an eighth embodiment of the present invention includes a heating element 120, wherein the heating element 120 includes a plurality of heating layers. Furthermore, the film heating unit 100 according to the eighth embodiment of the present invention is configured to enable independent control of the plurality of heating layers by a single power supply part.

The heating element 120 includes a first heating layer 150 and a second heating layer 160. The first heating layer 150 and the second heating layer 160 are each formed in a very thin sheet shape and are laminated in the thickness direction. More specifically, the first heating layer 150 includes a left side heating pattern 135, a right side heating pattern 145, and a left side electrode. Additionally, the second heating layer 160 includes a right side electrode.

In other words, the left side heating pattern 135 for generating heat according to the application of power is formed on one side (left side) of the first heating layer 150 based on approximately the central part in the length direction, and the right side heating pattern 145 is formed on the other side (right side) by application of power. Additionally, no heating pattern is formed on the second heating layer 160.

In addition, the first heating layer 150 further includes a right side connecting part 128. The right side connecting part 128 is to be connected to the right side electrode of the second heating layer 160, and performs a heating control of the right side heating pattern 145 formed on the right side of the first heating layer 150 by power control applied to the right side electrode of the second heating layer 160.

The left side heating pattern 135 functions as a left side heating part, and the right side heating pattern 145 functions as a right side heating part. The left side electrode includes a positive (+) electrode 123 and a negative (−) electrode 125, and the right side electrode includes a positive (+) electrode 124 and a negative (−) electrode 125. The negative (−) electrode 125 for the first heating layer 150 and the second heating layer 160 is commonly used. Through the above configuration, a temperature difference between the left side and the right side can be formed with one type of heating element specification to realize a dual automatic temperature control (DATC) function.

The heating device for a vehicle according to the present invention has been described with reference to the embodiments shown in the drawings, but this is merely exemplary, and it should be understood that anyone skilled in the art can make various modifications and equivalent other embodiments from this. Therefore, the true technical protection scope should be determined by the technical idea of the attached patent claim scope.

What is claimed is:

1. A heating device for a vehicle comprising:
a film heating unit which includes a heating element, and a film covering both sides of the heating element in the thickness direction; and
a heat dissipation unit which includes a pair of plates spaced apart from each other in the thickness direction, and a heat-dissipating fin which is interposed between the pair of plates,
wherein the film heating unit and the heat dissipation unit are sequentially laminated by attaching the plates to the film.

2. The heating device according to claim 1, wherein the heating element is connected to a positive (+) electrode and a negative (−) electrode as a conductor, and the film is made with an insulator to insulate between the heating element and the heat dissipation unit.

3. The heating device according to claim 1, wherein the heat dissipation unit is made by brazing the plates and the heat-dissipating fins, and then, is bonded to the thin film heating unit.

4. The heating device according to claim 1, further comprising:
a gap maintaining means which is provided between the plate and the film.

5. The heating device according to claim 4, wherein a protrusion of an embossed shape is formed on one side of the plate facing the film.

6. The heating device according to claim 4, wherein a grid pattern is formed on one side of the plate facing the film.

7. The heating device according to claim 1, wherein a bending part is formed at the end of the plate, and the bending part covers and supports the side of the film heating unit.

8. The heating device according to claim 7, wherein the bending part is formed on only one of the pair of plates facing each other in one heat dissipation unit, and
wherein the film heating unit is inserted between the plate, on which the bending part of one heat dissipation unit is formed, and the plate, on which the bending part of one heat dissipation unit is not formed, and then, is compressed, supported, and clamped to the bending part of the plate facing the plate, on which the bending part of one heat dissipation unit is not formed.

9. The heating device according to claim 3, wherein a bonding layer between the film heating unit and the heat dissipation unit is made by silicon bonding.

10. The heating device according to claim 1, wherein the multiple laminated film heating unit and heat dissipation unit are insulated from each other, and
wherein terminals are provided to individually supply power to the electrodes connected to the heating element of each film heating unit.

11. A heating device for a vehicle comprising:
a film heating unit which includes a heating element connected to a positive (+) electrode and a negative (−) electrode as a conductor, and a film covering both sides of the heating element in the thickness direction and made with an insulator,
wherein the heating element includes a plurality of heating layers, and
wherein the plurality of heating layers can be controlled independently by a single power supply part.

12. The heating device according to claim 11, wherein the heating element includes a left side heating part and a right heating part, and is configured to control the temperatures on the left and right sides inside the vehicle through independent control of the left heating part and the right heating part by a single power supply part.

13. The heating device according to claim 11, further comprising:
a heat dissipation unit which includes a pair of plates spaced apart from each other in the thickness direction, and a heat-dissipating fin interposed between the pair of plates,
wherein the plates are attached to the thin film, and the film heating unit and the heat dissipation unit are sequentially laminated.

14. The heating device according to claim 13, wherein a rigid base support is attached to one surface of the film heating unit, and the base support is in surface contact with the entire film heating unit to transfer heat to the plate.

15. The heating device according to claim 13, wherein the film heating unit includes an NTC resistor between the positive (+) electrode and the negative (−) electrode, and the NTC resistor induces current by lowering a resistance value when the temperature is above a reference temperature, thereby blocking the flow of current to the heating element.

16. The heating device according to claim 11, wherein the heating element includes a first heating layer and a second heating layer laminated in the thickness direction,
wherein the first heating layer includes a left side heating pattern and a left side electrode, and
wherein the second heating layer includes a right side heating pattern and a right side electrode.

17. The heating device according to claim 11, wherein the heating element includes a first heating layer and a second heating layer laminated in the thickness direction,
wherein the first heating layer includes a left side heating pattern, a right side heating pattern, and a left side electrode,
wherein the second heating layer includes a right side electrode, and
wherein the first heating layer has a right side connection part to be connected to the right side electrode of the second heating layer.

18. The heating device according to claim 16, wherein the negative (−) electrode for the first heating layer and the second heating layer is commonly used.
